(19) United States
(12) Patent Application Publication
(10) Pub. No.: US 2013/0167127 A1
(43) Pub. Date: Jun. 27, 2013

(54) SYSTEM, APPARATUS, AND METHOD FOR DISTRIBUTED COMPILATION OF APPLICATIONS

(71) Applicants: Bon-Cheol GU, Seongnam-si (KR); Kyung-Ah CHANG, Seoul (KR); Eun-Sung JUNG, Seongnam-si (KR)

(72) Inventors: Bon-Cheol GU, Seongnam-si (KR); Kyung-Ah CHANG, Seoul (KR); Eun-Sung JUNG, Seongnam-si (KR)

(73) Assignee: Samsung Electronics Co., Ltd., Suwon-si (KR)

(21) Appl. No.: 13/721,324

(22) Filed: Dec. 20, 2012

(30) Foreign Application Priority Data
Dec. 23, 2011 (KR) 10-2011-0141194

(51) Int. Cl. G06F 9/45; H04L 29/08

(52) U.S. Cl. CPC G06F 8/41; H04L 29/08135
USPC 717/140

(57) ABSTRACT

Provided is a system for distributed multi-stage compilation of application programs in a cloud environment. The system includes a source apparatus to generate a compilation order in which source representation of an application program is compiled, and a destination apparatus to receive a compiled representation created by compiling at least a portion of the source representation according to the compilation order.

### CROSS-REFERENCE TO RELATED APPLICATION(S)

This application claims the benefit under 35 USC §119(a) of Korean Patent Application No. 10-2011-0141194, filed on Dec. 23, 2011, in the Korean Intellectual Property Office, the entire disclosure of which is incorporated herein by reference for all purposes.

### BACKGROUND

1. Field

The following description relates to a technique for distributed multi-stage compilation of application programs.

2. Description of the Related Art

In the future of cloud computing, it is expected that various computing devices capable of communicating with each other through machine-to-machine (M2M) or a broadband network will configure a collaboration network in an Ad-hoc manner. It is also expected that heterogeneous computing devices, for example, a sensor, a smart phone, a tablet PC, a desktop computer, a cloud, and the like, having various form factors will drive specified platforms. It is also expected that various characteristics, for example, CMP, GPGPU, DSP, FPGA, and the like, will coexist on the same platform due to the application of many-cores and heterogeneous programmable processors.

For efficient collaboration between heterogeneous devices in an environment in which the heterogeneous devices coexist, heterogeneous software and hardware already installed in the individual devices could be used. However, existing collaboration techniques for a distributed system are limited in dynamically configuring an ad-hoc collaboration environment because these distributed systems are designed for a static environment.

### SUMMARY

In an aspect, there is provided a distributed compilation system for an application program, the distributed compilation system including a source apparatus configured to generate a compilation order in which a source representation of the application program is to be compiled, and a destination apparatus configured to receive a compiled representation created by compiling at least a portion of the source representation according to the compilation order, and to install the application program based on the compiled representation.

The compiled representation may comprise a compilation group of the source representation allocated to the source apparatus and compiled by the source apparatus according to the compilation order.

The distributed compilation system may further comprise at least one intermediate apparatus configured to compile a compilation group allocated to the intermediate apparatus according to the compilation order, and to transmit the result of the compilation to a next apparatus, wherein the compiled representation comprises the result of compilation by the intermediate apparatus.

The source apparatus may create metadata comprising profile information of the destination apparatus, the profile information comprising at least one of CPU information, OS information, memory information, and library information, of the destination apparatus.

The compiled representation may be created by compiling the source representation based on the profile information of the destination apparatus such that the compiled representation meets a compilation environment of the destination apparatus.

The source apparatus may set a compilation policy and configure the compilation order according to the compilation policy.

The compilation policy may be decided based on at least one of energy consumption minimization in the distributed compilation system, energy consumption minimization in one of the source apparatus and the destination apparatus, and minimization of a distribution time of the application program.

In an aspect, there is provided a distributed compilation apparatus for an application program, the distributed compilation apparatus including a compilation configuring unit configured to generate a compilation order in which a source representation of an application program is distributively compiled by at least one apparatus, a compiler configured to compile the compilation group of the source representation to create a compiled representation, if the source representation includes a compilation group to be compiled by the distributed compilation apparatus, and a transmitter configured to transmit the source representation or the compiled representation to a next apparatus according to the compilation order.

The distributed compilation apparatus may further comprise a policy setting unit configured to set a compilation policy, wherein the compilation configuring unit configures the compilation order according to the compilation policy.

The compilation policy may be decided based on at least one of energy consumption minimization in the distributed compilation system, energy consumption minimization in one of the source apparatus and the destination apparatus, and minimization of a distribution time of the application program.

The distributed compilation apparatus may further comprise an apparatus manager configured to manage apparatus information including compilation performance of a plurality of apparatuses, wherein the compilation configuring unit allocates two or more compilation groups of the source representation to two or more apparatuses of the plurality of apparatuses based on the apparatus information.

In an aspect, there is provided a distributed compilation method for an application program, the distributed compilation method including configuring, by a source apparatus, a compilation order in which source representation of the application program is compiled, receiving, by a destination apparatus, a compiled representation created by compiling at least a portion of the source representation according to the compilation order, and installing, by the destination apparatus, the application program based on the received compiled representation.

The distributed compilation method may further comprise creating, at the source apparatus, the compiled representation by compiling a compilation group allocated to the source apparatus, from among the compilation groups of the source representation, according to the compilation order.

The distributed compilation method may further comprise compiling, at an intermediate apparatuses, a compilation group allocated to the intermediate apparatus and received in a compiled representation according to the compilation order, and transmitting the result of the compilation to a next apparatus, wherein the compiled representation is the result of compilation by the intermediate apparatus.

The configuring of the compilation order may comprise setting a compilation policy and configuring the compilation order according to the compilation policy.

The compilation policy may be decided based on at least one of energy consumption minimization in a distributed compilation system, energy consumption minimization in one of the source apparatus and the destination apparatus, and minimization of a distribution time of the application program.

In an aspect, there is provided a distributed compilation method for an application program, the distributed compilation method including configuring a compilation order in which source representation of the application program is compiled, compiling, if the source representation includes a compilation group that is to be compiled according to the compilation order, the compilation group of the source representation to create a compiled representation, and transmitting the source representation or the compiled representation to a next apparatus according to the compilation order.

The configuring of the compilation order may comprise setting a compilation policy and configuring the compilation order according to the compilation policy.

The compilation policy may be decided based on at least one of energy consumption minimization in a distributed compilation system, energy consumption minimization in a compilation apparatus, and minimization of a distribution time of the application program.

The configuring of the compilation order may comprise configuring the compilation order by allocating two or more compilation groups to two or more apparatuses based on apparatus information including compilation performance of the apparatuses.

In an aspect, there is provided a terminal including a receiver configured to receive a source representation of an application which has been distributively compiled by a plurality of heterogeneous devices, and a controller configured to install and execute the application based on the distributively compiled source representation.

The terminal may further comprise a compiler configured to further compile the distributively compiled source representation to generate a target representation, wherein the controller is configured to install and execute the application based on the target representation.

The application may comprise a cloud server application stored on a cloud server, and the plurality of heterogeneous devices may comprise the cloud server and at least one intermediate device between the cloud server and the terminal, and the cloud server and the at least one intermediate device may each compile a portion of the source representation of the cloud server application.

Other features and aspects will be apparent from the following detailed description, the drawings, and the claims.

### BRIEF DESCRIPTION OF THE DRAWINGS

FIG. 1 is a diagram illustrating an example of a distributed compilation system.

FIG. 2 is a diagram illustrating an example in which source representation is compiled into target representation through multi-stage compilation.

FIG. 3 is a diagram illustrating an example in which source representation is distributively compiled by a plurality of apparatuses through multi-stage compilation.

FIG. 4 is a diagram illustrating an example of a source apparatus.

FIG. 5 is a flowchart illustrating an example of a distributed compilation method.

FIG. 6 is a flowchart illustrating an example of a distributed compilation method which is performed by a source apparatus.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, examples of a system, apparatus, and method for distributed multi-stage compilation of application programs are described.

In general, an application program is distributed by distributing source codes of the program to an apparatus in which the program will be installed and then causing the apparatus to compile the source codes, or by compiling the program into a file which is suitable for an apparatus in which the application program will be installed and then copying the file to the apparatus.

Recently, the distributed compilation system has been applied to a situation in which a user of a mobile device desires to install and execute various application programs stored in a cloud server. According to various aspects, by delegating the compilation of application program source codes, which is typically performed by the cloud server or by the mobile device having limited resources, to other apparatuses, the distribution cost of the application program may be reduced and the distribution efficiency of the application program may be improved.

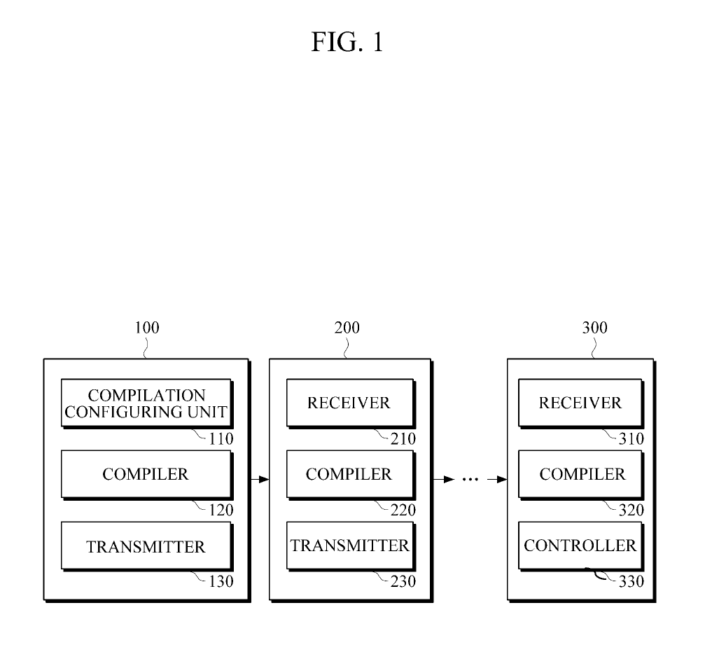

FIG. 1 illustrates an example of a distributed compilation system for an application program.

Referring to FIG. 1, the distributed compilation system includes a source apparatus 100 and a destination apparatus 300. The source apparatus 100 may store source representation of source codes of an application program. The source apparatus 100 may distribute the application program to the destination apparatus 300 in response to a request from the destination apparatus 300. For example, the source apparatus 100 may be a cloud server or an application server that performs distributed computing. As another example, the source apparatus 100 may be an arbitrary apparatus that can store source representation of source codes of an application program and perform network communication. The destination apparatus 300 may be a terminal, for example, a mobile phone, a computer, a tablet, an appliance, a sensor, and the like.

In this example, the source apparatus 100 includes a compilation configuring unit 110, a compiler 120, and a transmitter 130. The compilation configuring unit 110 may divide source representation into a plurality of compilation groups and allocate the compilation groups to one or more apparatuses to configure a compilation order. For example, the compilation configuring unit 110 may create compilation order information in which the individual compilation groups are mapped to identifiers (IDs) of compilation apparatuses that will compile the compilation groups. The compile configuring unit 110 may configure a compilation order such that the source apparatus 100 or the destination apparatus 300 compiles all of the compilation groups or such that the compilation groups are distributed and compiled by the source apparatus 100 and the destination apparatus 300.

In various aspects, the distributed compilation system may further include at least one intermediate apparatus 200. In this example, the compile configuring unit 110 may delegate one or more of the compilation groups to the intermediate apparatus 200. The compile configuring unit 110 may configure the compilation order according to a predetermined compilation policy. For example, the predetermined compilation policy may be based on energy consumption minimization in the distributed compilation system, minimization of a distribution time of the application program, and the like.

In addition, the compilation configuring unit 110 may configure the compilation order by selecting compilation apparatuses that are suitable for the predetermined compilation policy based on apparatus information. For example, the apparatus information may include the compilation performance information of the apparatuses that are managed by the source apparatus 100.

In various aspects, the compilation configuring unit 110 may create metadata including the compilation order information. For example, the metadata may include profile information about at least one of the CPU, OS, memory, and library information of the respective destination apparatus 300.

If there is a compilation group that is to be compiled by the compiler 120, the compiler 120 may compile the compilation group. There may be one or more compilation groups. The results of the compilation may be used as input values in the next stage. The compiled representation obtained after the final compilation stage may be transmitted to the next apparatus. The term “compiled representation” may be used to refer to an intermediate representation that is obtained by compiling one or more of but not all of the compilation groups of a source representation, or a target representation that is obtained by compiling all compilation groups of the source representation.

For example, the compiler 120 may compile the source representation based on profile information of the destination apparatus 300 to create a compiled representation that is suitable for the compilation environment of the destination apparatus 300. As another example, according to the compilation order configured by the compilation configuring unit 110, there may be no compilation group that is compiled by the source apparatus 100.

The transmitter 130 may transmit the intermediate representation compiled by the compiler 120 or the source representation (if there is no compilation group allocated to the corresponding compilation apparatus) to the next compilation apparatus. For example, the apparatus that will compile the next compilation group may be the intermediate apparatus 200 or the destination apparatus 300.

In addition, the transmitter 130 may transmit metadata created by the compilation configuring unit 110 to the apparatus that will compile the next compilation group. Accordingly, the apparatus may recognize a compilation group that is allocated to the apparatus by checking the received metadata, and may also recognize the compilation environment of the destination apparatus 300.

In this example, by delegating the compilation of source representation to a plurality of apparatuses based on dynamic consideration of the compilation performance, compilation environments, and the like, of the individual apparatuses, it is possible to distribute an application program to the destination apparatus 300 to more efficiently compile the application program.

The intermediate apparatus 200 may compile at least a portion of the source representation of an application program that is distributed from the source apparatus 100 to the destination apparatus 300. In this example, the intermediate apparatus 200 includes a receiver 210, a compiler 220, and a transmitter 230. There may be one or more intermediate apparatuses 200. The receiver 210 of the intermediate apparatus 200 may receive source representation or intermediate representation that is the result from compiling a portion of the source representation, from the source apparatus 100. In some example, the receiver 210 may also receive metadata.

A compilation group may be allocated to the intermediate apparatus 200. The compilation group may include a compilation representation such as a source representation or an intermediate representation. The compilation group may be allocated according to a compilation order included in the metadata. The transmitter 230 may transmit the compiled representation (intermediate representation or target representation) and the metadata to the destination apparatus 300.

If the compilation configuring unit 110 configures a compilation order such that the intermediate apparatus 200 compiles the final compilation group of the source representation, the result of compilation by the intermediate apparatus 200 is the target representation. As another example, if the compilation configuring unit 110 configures a compilation order such that the remaining compilation group of source representation is compiled by the destination apparatus 300 or another intermediate apparatus, the result of compilation by the intermediate apparatus 200 is intermediate representation.

According to various aspects, there may be a plurality of intermediate apparatuses 200. For example, the compilation configuration unit 110 of the source apparatus 100 may configure a compilation order such that first and second intermediate apparatuses 200 each compile a portion of source representation. In this example, the receiver 210 of the first intermediate apparatus 200 may receive the source representation or intermediate representation resulting from compiling the source representation, from the source apparatus 100, together with metadata. Then, the compiler 220 of the first intermediate apparatus 200 may compile a compilation group allocated thereto, and the transmitter 230 may transmit the compiled representation as an intermediate representation along with the metadata to the second intermediate apparatus 200.

In this example, the compiler 220 of the second intermediate apparatus 200 may compile a compilation group allocated thereto, and the transmitter 230 may transmit the resultant compiled representation (intermediate representation or target representation) to the destination apparatus 300. In this example, the compilation group may be allocated to the first and second intermediate apparatuses 200 based on the metadata.

The destination apparatus 300 corresponds to a device that installs and executes an application program distributed from the source apparatus 100. The destination apparatus 300 includes a receiver 310 and a compiler 320. The receiver 310 may receive a compiled representation (intermediate representation or target representation) from the source apparatus 100 or from the intermediate apparatus 200. If the receiver 310 receives the intermediate representation, the compiler 320 may compile a compilation group allocated thereto in the intermediate representation to thereby create a target representation.

In various examples, the destination apparatus may further include a controller 330 that installs and executes the application program based on the distributively compiled source representation.

According to the examples herein, the source apparatus 100, the one or more intermediate apparatuses 200, and the destination apparatus 3200 may distributively compile source representation. As another example, it is also possible that the source apparatus 100 and the destination apparatus 300 compile no compilation group and only the intermediate apparatuses 200 distributively compile source representation and transmit the result of the compilation to the destination apparatus 300 such that the destination apparatus 300 executes the result of the compilation.

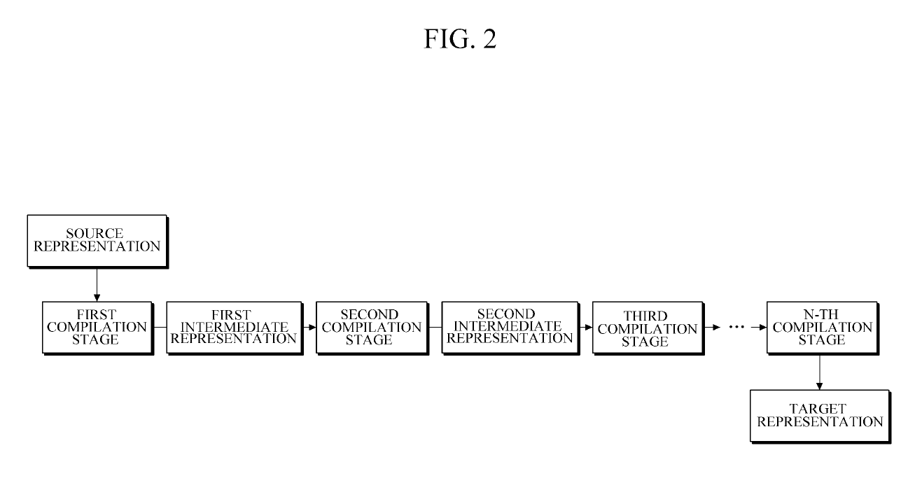

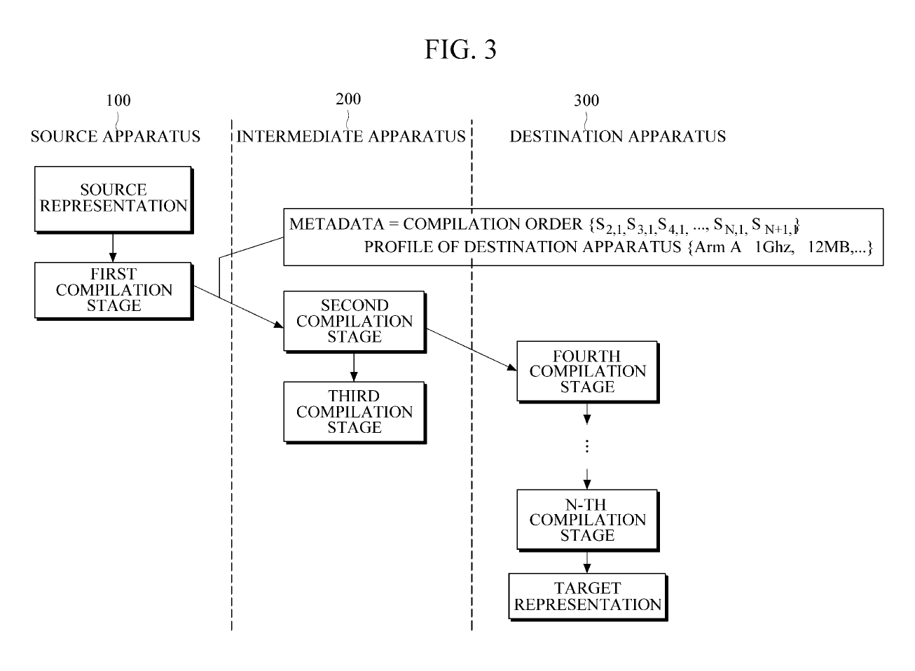

FIG. 2 illustrates an example in which source representation is compiled into target representation through multi-stage compilation, and FIG. 3 illustrates an example in which source representation is distributively compiled by a plurality of apparatuses through multi-stage compilation.

Referring to FIGS. 1 and 2, the compilation configuring unit 110 of the source apparatus 100 may divide a source representation of an application program into N compilation groups. For example, the compilation configuring unit 110 may configure the N compilation groups such that the individual compilation groups are compiled by multi-stage compilers of an apparatus or a plurality of apparatuses based on a predetermined compilation policy, based on apparatus information about the compilation performance, and the like, of the apparatuses. The compilers 120, 220, and 320 of the source apparatus 100, the intermediate apparatus 200, and the destination apparatus 300 may be multi-stage compilers that perform multi-stage compilation.

Source representation is subject to a first compilation stage to be compiled into a first intermediate representation, and the first intermediate representation is input to an apparatus that will apply a second compilation stage. The apparatus applies the second compilation stage to the first intermediate representation to create a second intermediate representation. In this example, after an N-th compilation stage which corresponds to a final compilation stage, a target representation is created.

FIG. 3 illustrates an example in which the N compilation groups are distributively compiled by the source apparatus 100, the intermediate apparatus 200, and the destination apparatus 300.

Referring to FIGS. 2 and 3, the source apparatus 100 compiles a first compilation group of the source representation to create a first intermediate representation, and transmits the first intermediate representation to the intermediate apparatus 200. In addition, the source apparatus 100 may transmit metadata together with the first intermediate representation, to the intermediate apparatus 200.

For example, the metadata may include a compilation order, and the like. The compilation order information may include individual compilation groups which are mapped to the IDs of apparatuses that will compile the compilation group. As an additional example, the metadata may include profile information of the destination apparatus 300. The profile information may include information about the CPU, OS, memory, library information, and the like of the destination apparatus 300. Each apparatus may compile a received representation based on the profile information of the destination apparatus 300 to create an intermediate representation that is suitable for the compilation environment of the destination apparatus 300.

The intermediate apparatus 200 may receive the first intermediate representation and may also receive the metadata. In the example of FIG. 3, the intermediate apparatus 200 compiles the second and third compilation groups allocated to the intermediate apparatus 200. For example, the intermediate apparatus 200 may compile the second compilation stage of the first intermediate representation to create a second intermediate representation, and then compile the third compilation group of the second intermediate representation to create a third intermediate representation. Then, the intermediate apparatus 200 transmits the third intermediate representation to the destination apparatus 300. In this example, the intermediate apparatus 200 may also transmit the metadata to the destination address 300.

The destination apparatus 300 compiles a fourth compilation group of the third intermediate representation to create a fourth intermediate representation, and compiles a fifth compilation stage of the fourth intermediate representation. By compiling an N-th compilation group which corresponds to a final compilation stage, the destination apparatus 300 creates a target representation.

FIG. 3 illustrates an example in which source representation is distributively compiled by the source apparatus 100, the intermediate apparatus 200, and the destination apparatus 300. However, it should be appreciated that this is merely an example, and it is also possible that source representation may be compiled by any one or more of the source apparatus 100, the intermediate apparatus 200, and the destination apparatus 300, or by two or more intermediate apparatuses 200 to create target representation. In other words, it is possible that a compilation policy and the compilation environments of individual apparatuses may be variously combined to configure a compilation order.

As an example, an intermediate representation that is created by each apparatus may be independently distributed to apparatuses that require the intermediate representation so as to allow more apparatuses to execute the corresponding application program. As another example, the source apparatus 100, the intermediate apparatus 200, and/or the destination apparatus 300 may further include a profile DB (not shown) that stores the profile information of the destination apparatus 300. For example, the metadata may not contain profile information of the destination apparatus 300. As another example, each of the source apparatus 100 and the intermediate apparatus 200 may check their own profile DB (not shown) and perform compilation according to the compilation environment of the destination apparatus 300 to thereby create compiled representation.

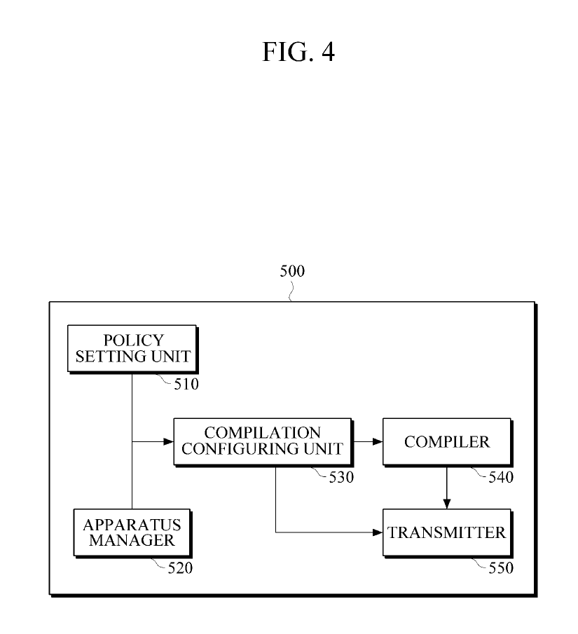

FIG. 4 illustrates an example of a source apparatus in a distributed compilation system for an application program. As described above with reference to FIG. 1, the source apparatus 500 may include a compilation configuring unit 530, a compiler 540, and a transmitter 550. The compilation configuring unit 530, the compiler 540, and the transmitter 550 are described herein with reference to FIG. 1. In the example of FIG. 4, the source apparatus 500 further includes a policy setting unit 510 and an apparatus manager 520.

The policy setting unit 510 may set various compilation policies. For example, the policy setting unit 510 may receive a policy suitable for an application program from a policy manager before distributing the application program. As another example, a compilation policy may automatically be set according to predetermined criteria, such as the size of an application program, network communication states with specific apparatuses, and the like. The predetermined compilation policy may be decided in consideration of energy/cost consumption minimization in the distributed compilation system and a specific apparatus that will perform compilation, minimization of a distribution time of the application program, and the like.

For example, if the size of an application program that is to be transmitted to a destination apparatus (not shown) is large, the policy setting unit 510 may set a policy for minimizing a distribution time. As another example, if the size of the application program is relatively small, the policy setting unit 510 may set a policy for minimizing energy consumption of the system.

The apparatus manager 520 may manage apparatus information about the apparatuses that are managed by the source apparatus 500. The apparatus information may include the compile performance, energy consumption levels, compilation cost, and the like, of the individual apparatuses. In addition, the source apparatus 500 may further include an apparatus management DB (not shown), and the apparatus manager 520 may store the apparatus information about the individual apparatuses in the apparatus management DB to manage the apparatus information.

The compilation configuring unit 530 may configure a compilation order of a source representation based on the apparatus information of the apparatuses such that the compiled representation meets the compilation policy. For example, a compilation policy for minimizing a distribution time may be set. Accordingly, a compilation order may be configured in such a way to select apparatuses that have the highest compilation performance and highest network speed to perform the compilation.

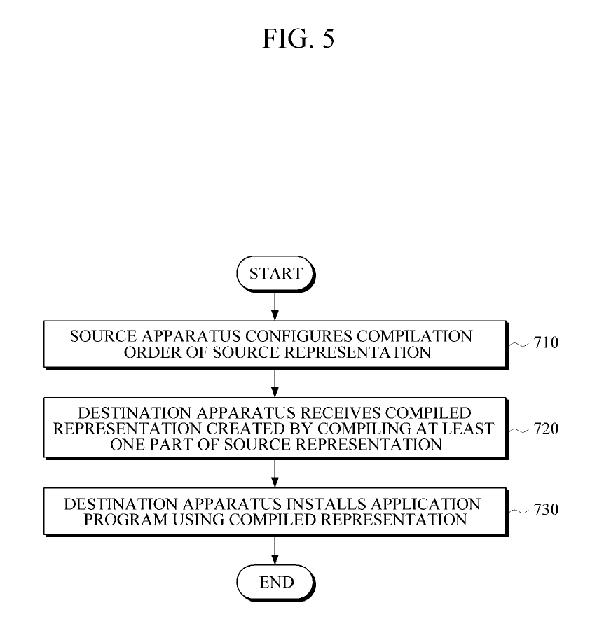

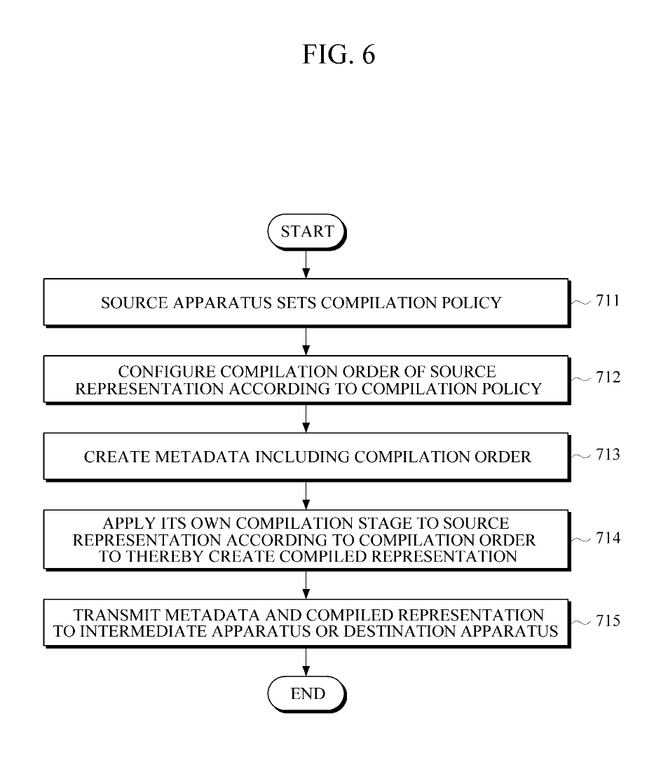

FIG. 5 illustrates an example of a distributed compilation method for application program, and FIG. 6 illustrates an example of a distributed compilation method for an application program, which is performed by a source apparatus. Hereinafter, a distributed multi-stage compilation method for application program will be described with reference to FIGS. 1, 5 and 6.

The source apparatus 100 configures a compilation order of source representation (710). Referring to FIG. 6, the source apparatus 100 sets a compilation policy (711). For example, the compilation policy may be decided in consideration of energy consumption minimization in the distributed compilation system and a specific apparatus that will perform compilation, minimization of a distribution time of the application program, and the like.

The source apparatus 100 configures a compilation order of source representation according to the compilation policy (712). For example, the source apparatus 100 may decide compilation groups for the source representation, compilation apparatuses that will compile the respective compilation groups, and the like, based on the compilation performance, compilation cost, energy consumption levels, and the like, of the apparatuses, such that the compiled representation meets the compilation policy. Accordingly, the source apparatus 100 may associate the compilation groups with the compilation apparatuses, thereby configuring the compilation order.

Metadata is created (713). For example, the metadata may include the compilation order and profile information of a destination apparatus, such as the CPU, OS, memory, and library information of the destination apparatus.

If one or more compilation groups are allocated to the source apparatus 100, the source apparatus 100 compiles the compilation group of the source representation, according to the compilation order, to create a compiled representation (714). If there is no compilation stage that will be compiled by the source apparatus 100, the operation 714 may be omitted.

Thereafter, the source apparatus 100 transmits the metadata including the compilation order or the profile information, and the source representation or the compiled representation to the intermediate apparatus 200 or the destination apparatus 300 that will compile the next compilation group (715). For example, an apparatus that will compile the next compilation group may be determined from the compilation order included in the metadata.

The destination apparatus 300 receives the compiled representation which has been created by compiling at least one part of the source representation (720). As described above, the compiled representation may have been created by the intermediate apparatus 200 according to the compilation order. The compiled representation may be a target representation obtained by compiling all compilation groups of the source representation, or may be an intermediate representation obtained by compiling some of the compilation groups of the source representation.

The destination apparatus 300 installs and executes the application program using the compiled representation (target representation or intermediate representation) received from the source apparatus 100 or the intermediate apparatus 200 (730). If the destination apparatus 300 receives target representation, the destination apparatus 300 may install and execute the application program using the target representation. As another example, if the destination apparatus 300 receives intermediate representation, the destination apparatus 300 may compile the remaining compilation group of the intermediate representation to thereby create target representation, and then install the application program using the target representation.

In various aspects, there is provided a distributive compilation technology which enables a source device to distribute the compilation of source code to a plurality of devices to enable distributive compilation of the source code. Accordingly, compilation efficiency may be increased.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A distributed compilation system for an application program, the distributed compilation system comprising:
a source apparatus configured to generate a compilation order in which a source representation of the application program is to be compiled; and
a destination apparatus configured to receive a compiled representation created by compiling at least a portion of the source representation according to the compilation order, and to install the application program based on the compiled representation.

2. The distributed compilation system of claim 1, wherein the compiled representation comprises a compilation group of the source representation allocated to the source apparatus and compiled by the source apparatus according to the compilation order.

3. The distributed compilation system of claim 1, further comprising at least one intermediate apparatus configured to compile a compilation group allocated to the intermediate apparatus according to the compilation order, and to transmit the result of the compilation to a next apparatus,
wherein the compiled representation comprises the result of compilation by the intermediate apparatus.

4. The distributed compilation system of claim 1, wherein the source apparatus creates metadata comprising profile information of the destination apparatus, the profile information comprising at least one of CPU information, OS information, memory information, and library information, of the destination apparatus.

5. The distributed compilation system of claim 4, wherein the compiled representation is created by compiling the source representation based on the profile information of the destination apparatus such that the compiled representation meets a compilation environment of the destination apparatus.

6. The distributed compilation system of claim 1, wherein the source apparatus sets a compilation policy and configures the compilation order according to the compilation policy.

7. The distributed compilation system of claim 6, wherein the compilation policy is decided based on at least one of energy consumption minimization in the distributed compilation system, energy consumption minimization in one of the source apparatus and the destination apparatus, and minimization of a distribution time of the application program.

8. A distributed compilation apparatus for an application program, the distributed compilation apparatus comprising:
a compilation configuring unit configured to generate a compilation order in which a source representation of an application program is distributively compiled by at least one apparatus;
a compiler configured to compile the compilation group of the source representation to create a compiled representation, if the source representation includes a compilation group to be compiled by the distributed compilation apparatus; and
a transmitter configured to transmit the source representation or the compiled representation to a next apparatus according to the compilation order.

9. The distributed compilation apparatus of claim 8, further comprising a policy setting unit configured to set a compilation policy,
wherein the compilation configuring unit configures the compilation order according to the compilation policy.

10. The distributed compilation apparatus of claim 9, wherein the compilation policy is decided based on at least one of energy consumption minimization in the distributed compilation system, energy consumption minimization in one of the source apparatus and the destination apparatus, and minimization of a distribution time of the application program.

11. The distributed compilation apparatus of claim 8, further comprising an apparatus manager configured to manage apparatus information including compilation performance of a plurality of apparatuses,
wherein the compilation configuring unit allocates two or more compilation groups of the source representation to two or more apparatuses of the plurality of apparatuses based on the apparatus information.

12. A distributed compilation method for an application program, the distributed compilation method comprising:
configuring, by a source apparatus, a compilation order in which source representation of the application program is compiled;
receiving, by a destination apparatus, a compiled representation created by compiling at least a portion of the source representation according to the compilation order; and
installing, by the destination apparatus, the application program based on the received compiled representation.

13. The distributed compilation method of claim 12, further comprising creating, at the source apparatus, the compiled representation by compiling a compilation group allocated to the source apparatus, from among the compilation groups of the source representation, according to the compilation order.

14. The distributed compilation method of claim 12, further comprising compiling, at an intermediate apparatuses, a compilation group allocated to the intermediate apparatus and received in a compiled representation according to the compilation order, and transmitting the result of the compilation to a next apparatus,
wherein the compiled representation is the result of compilation by the intermediate apparatus.

15. The distributed compilation method of claim 12, wherein the configuring of the compilation order comprises setting a compilation policy and configuring the compilation order according to the compilation policy.

16. The distributed compilation method of claim 15, wherein the compilation policy is decided based on at least one of energy consumption minimization in a distributed compilation system, energy consumption minimization in one of the source apparatus and the destination apparatus, and minimization of a distribution time of the application program.

17. A distributed compilation method for an application program, the distributed compilation method comprising:
configuring a compilation order in which source representation of the application program is compiled;
compiling, if the source representation includes a compilation group that is to be compiled according to the compilation order, the compilation group of the source representation to create a compiled representation; and
transmitting the source representation or the compiled representation to a next apparatus according to the compilation order.

18. The distributed compilation method of claim 17, wherein the configuring of the compilation order comprises setting a compilation policy and configuring the compilation order according to the compilation policy.

19. The distributed compilation method of claim 18, wherein the compilation policy is decided based on at least one of energy consumption minimization in a distributed compilation system, energy consumption minimization in a compilation apparatus, and minimization of a distribution time of the application program.

20. The distributed compilation method of claim 17, wherein the configuring of the compilation order comprises configuring the compilation order by allocating two or more compilation groups to two or more apparatuses based on apparatus information including compilation performance of the apparatuses.

21. A terminal comprising:
a receiver configured to receive a source representation of an application which has been distributively compiled by a plurality of heterogeneous devices; and
a controller configured to install and execute the application based on the distributively compiled source representation.

22. The terminal of claim 21, further comprising a compiler configured to further compile the distributively compiled source representation to generate a target representation,
wherein the controller is configured to install and execute the application based on the target representation.

23. The terminal of claim 21, wherein the application comprises a cloud server application stored on a cloud server, and the plurality of heterogeneous devices comprise the cloud server and at least one intermediate device between the cloud server and the terminal, and
the cloud server and the at least one intermediate device each compile a portion of the source representation of the cloud server application.
